(19) United States
(12) Patent Application Publication
(10) Pub. No.: US 2002/0093144 A1
(43) Pub. Date: Jul. 18, 2002

(54) Sealing mechanism for fluid and pipe connector using sealing mechanism

(76) Inventor: Jun Taga, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 09/988,717

(22) Filed: Nov. 20, 2001

(30) Foreign Application Priority Data
Nov. 24, 2000 (JP) 357872/2000
Nov. 9, 2001 (JP) 344622/2001

(51) Int. Cl. F16L 5/02

(52) U.S. Cl. 277/607

(57) ABSTRACT

The present invention is a sealing mechanism for fluid for preventing leakage of fluid from a portion of threads of two members 2, 3 that are connected to each other via the threads, at least one of the two members having a hole of circular cross section for accommodating the fluid formed therein. The sealing mechanism for fluid includes an receiving portion 24 formed in an inner periphery of the hole and having a diameter larger than a diameter of the hole and a desired axial length, and a tubular seal member 10 having an axial length longer than the axial length of the receiving portion, in which the two members and the tubular seal member is made of the same kind of fluororesin, and when the two members are interconnected by engagement of the threads, the tubular seal member is axially compressed and deformed by at least 5% or more.

### BACKGROUND OF THE INVENTION

The present invention relates to a sealing mechanism for fluid and a seal member for the sealing mechanism, and more specifically, to a sealing mechanism for fluid, such as a pipe connector structure, that is suitable for use in a fluidic device for interconnecting two tubes or pipes (hereinafter, collectively referred to as a pipe) or interconnecting a valve or other device main body and a pipe and utilizes a thin tubular seal member, and a tubular seal member.

The pipe connector is used in a considerable number of industries as described above. While a pipe connector which is made of TFE (polytetrafluoroethylene) or PFA (copolymer of TFE and perfluoroalkylvinylether), each of which is a kind of fluoro-resin, and which is often used in the semiconductor manufacturing field, will be explained in the description of the present invention, the present invention is not limited thereto and may be effectively used for pipe connectors made of other materials.

Typical connectors made of fluoro-resin are the following:

(1) that disclosed in Utility Model Laid-Open Publication No. Shou 61-145183;

(2) that disclosed in Utility Model Publication No. Hei 4-52556;

(3) that disclosed in the specification and the drawings of U.S. Pat. No. 5,439,259;

(4) that disclosed in the specification and the drawings of U.S. Pat. No. 3,977,708.

However, since these conventional connectors are made of TFE or PFA, each of which is a kind of plastic, axial and radial loads exerted for a long time by the inner pressure of the fluid in the pipe connectors cause creep at a coupling portion by threads and also cause loosening of the coupling portion to produce fine crevices between adjacent parts, thereby causing leakage of the inside fluid at the portion.

Leakage due to the creep typically occurs at two positions in the coupling thread portions of the connector structure. A first portion is a thread joint portion connecting a tube (or pipe), which is a fluid conduit external to the connector, and a connector main body with each other, while a second portion is a thread joint portion connecting the main body of the connector and a main device. The first portion will be described with reference to the connector structures of the above-mentioned prior art, which are shown by solid arrows in FIGS. 1 to 4. As shown in FIG. 1, the connector structure described in the publication set forth in the above (1) is configured so that a tube mount portion (b) of a tubular portion formed integrally with the connector main body a and having a tapered portion (c) formed at a tip end thereof is covered with a flared portion of a tube (d), a shoulder (g) of a cap nut (f) is pressed against the overlapping portion by the action of engagement of the internal thread of the cap nut (f) and the external thread of the connector main body, thereby preventing the removal of the tube from the connector main body and leakage of the fluid. In addition, the connector structure described in the publication set forth in the above (2) is configured, as shown in FIG. 2, so that a plug-like inner ring (j) covered with a tube (i) is inserted into a receiving portion (1) of the connector main body (k) together with the tube (i), the shoulder (n) of a cap nut (m) is pressed against the tube by means of the action of firm fastening by the threads of the cap nut and the main body as in the above described example, to press the tube against the tapered portion of the inner ring, thereby preventing the leakage of the fluid from the connection between the tip end of the inner ring and the connector main body and removal of the tube, and the connector main body (k) is brought into tight contact with the tapered surface formed on the inner ring (j), thereby preventing leakage of the fluid to the outside of the connector main body.

Alternatively, there is a connector structure described in the publication set forth in the above (3), which relates to the U.S. Patent. As shown in FIG. 3, the connector structure is configured so that a tip end of a tube (q) is folded to cover an inner tubular portion (p) of a cap nut (o), the inner tubular portion covered with the tube is inserted into a receiving portion of a connector main body (s), an internal thread formed on an outer tubular portion (r) of the cap nut (o) is engaged with an external thread formed on the connector main body, thereby bringing the folded portion of the tube into contact with a contact surface (t) of the connector main body to prevent the removal of the seal and the tube. Furthermore, in the connector structure disclosed in the publication set forth in the above (4), as shown in FIG. 4, a tube (w) is passed through the inside of a connector main body (u) and a cap nut (v), and on the outer periphery of the tube (w), a tip end (y) of a ferrule (x) of the cap nut is deformed by the connector main body (w) into the shape of an annular projection, which is engaged with a groove formed on the outer surface of the tube (u), thereby preventing the removal of the tube w from the connector main body (u).

However, the above described structure has a problem in that, in the case where the components are made of synthetic resin material and loosening occurs at the thread portion due to creep, since it is not configured to prevent loosening of the contact of the sealed surfaces, a clearance occurs between the connector main body and the tube (see FIGS. 1 and 3), and the leakage of the fluid occurs through a clearance generated between the connector main body and the inner ring or annular body (see FIGS. 2 and 4), so that the thread portion must be further fastened in order to maintain the sealing.

Next, a second portion of leakage occurrence due to creep in the thread portion is the thread joint portion (that may be an internal or external thread) of said tube and connector main body, which is indicated by a solid arrow in FIG. 5. The thread joint portion is a thread structure used in a joint portion between the connector main body and another device, such as a pump, valve, filter device, or container, or another form of pipe connector, for example, an elbow cheese union. While the thread used in the thread joint portion is shown as a parallel thread in the above publication and accompanying drawings, practically, it is a tapered thread (PT or NPT) in most cases as shown in FIG. 5, and the parallel thread is rarely adopted. Sealing of the thread joint portion is dominantly accomplished by the engagement force at the tapered thread portion, and the sealing due to pressure contact of contact surfaces of ends of the internal and external threads utilized in coupling of the parallel threads is not effected. The reason is as follows. In the connector structure made of TFE or PFA, creep inevitably occurs at the thread portion, so that if the parallel thread is adopted, it is required to provide a seal member made of elastomer or the like between the contact surfaces. However, such a seal member made of elastomer cannot be adopted in terms of corrosion resistance. This is because while TFE and PFA are extremely superior in corrosion resistance, any currently-available seal member made of elastomer other than extremely expensive perfluoroelastomer does not have corrosion resistance meeting the requirement.

In addition, even if the tapered threads are connected to each other with a head of the external thread initially being in contact with the bottom as in the case of the parallel thread, when creep is generated, the sealing force of the tapered thread is rapidly and significantly reduced. This is because even if the contact surfaces are brought into intimate contact with each other at this time by further fastening to recovering the sealing, the creep further advances due to properties of plastics, thereby producing a fine clearance. That is, the tapered thread portion cannot be expected to provide perfect sealing by itself in the connector structure made of fluororesin.

In this way, since, conventionally, a measure for preventing degradation of sealing due to loosening of the thread is not taken at the above described second portion of leakage, the thread must be often further fastened, and in order to accomplish perfect sealing, it is required to weld the thread at a base or end portion, so that the leakage of the fluid cannot be easily prevented.

Furthermore, the tapered thread has a serious defect besides the above described leakage of the fluid due to the creep. As described above, the sealing of the tapered thread portion is accomplished by the intimate contact between the external and internal threads provided by the advance of the tapered external thread for engagement, rather than by the contact between the end surfaces, and it is required to deal with the loosening of the thread caused by the occurrence of the creep, that is, the occurrence of a fine clearance by further fastening. Therefore, as shown in FIG. 5, a space G corresponding to several pitches that is required for further fastening must be provided at the ends of the tapered internal and external threads.

However, this space is located in the path of the delivered fluid and constitutes a so-called liquid pool, which reduces a displacement efficiency of the delivered fluid, so that it cannot absolutely be accepted in the pipe connector structure used in a semiconductor manufacturing facility. In the past, this significant and serious defect of the connector mechanism has been considered to be inevitable in terms of structure so that it has been avoided and passed unmentioned.

### BRIEF SUMMARY OF THE INVENTION

An object of the present invention is to provide a fluid sealing mechanism capable of preventing leakage of fluid even when creep that is caused by a material of two members connected to each other via threads occurs at a thread coupling portion and a tubular seal member for such a sealing mechanism.

Another object of the present invention is to provide a fluid sealing mechanism suitable for a pipe connector structure having no liquid pool in a fluid path and a tubular seal member for such a sealing mechanism.

Another object of the present invention is to provide a tubular seal member and a fluid sealing mechanism in which the tubular seal member is provided in a component made of fluororesin, the tubular seal member being made of the same material as the component and deformed by being axially pressed by the component, thereby compensating a clearance generated due to the creep at the thread coupling portion to prevent the leakage of the fluid from the joint portion.

As described above, in the connector structure made of TFE or the like, when a fine flow path occurs due to the creep at the fastening thread portion, the flow path must be sealed against leakage of fluid. However, as described above, the conventional seal member made of elastomer that is extremely suitable for sealing cannot be used in terms of corrosion resistance.

Therefore, according to the present invention, in order to make a fluororesin material (TFE, PFA or the like) that is too hard and inferior in flexibility for a seal material a superior seal material, the shape and application technique thereof are improved by adopting a completely novel idea. That is, a thin and axially elongated tubular seal member having a sealing function is devised. In the pipe connector structure constituted only by components (parts) made of fluororesin, the tubular seal member is disposed between adjacent parts constituting a passage, the tubular seal member being made of the same material as the parts, the pipe connector structure and the seal member that are made of a kind of a plastomer (plastic), which is not an elastomer (elastic body), are axially pressed and deformed between the adjacent parts by fastening the coupling threads, which are components of the connector, and a fine clearance (leakage path) produced between the parts due to creep phenomenon occurring at the thread coupling portion is filled by the action of the elastic resilience and shape restoring capability of the material generated at the time, thereby providing a sealing effect at both end surfaces of the tubular seal member.

In general, it is impossible that, in a structure constituted by a plurality of parts made of the same material, that a seal member (gasket) made of the same material is used as a seal member between the parts. This is because it has been considered that the seal member of the same material as that of the other parts cannot serve as a seal, and the seal member should be made of an elastic material softer than the material of the other parts.

Specifically, one aspect of the invention of the present application is a sealing mechanism for fluid for preventing leakage of fluid from a portion of threads of two members that are connected to each other via the threads, at least one of the two members having a hole for accommodating the fluid formed therein, the sealing mechanism being configured to comprise a receiving portion formed in an inner periphery of the hole and having a diameter larger than a diameter of the hole and a desired axial length, and a tubular seal member having an axial length longer than the axial length of the receiving portion, in which the tubular seal member is made of fluororesin, and when the two members are interconnected by engagement of the threads, the tubular seal member is axially compressed and deformed by at least 5% or more, thereby providing a strong sealing on at least one end surface of the tubular seal member, and at the same time the tubular seal member is pressed into contact with the inner peripheral surface of the receiving portion, thereby providing a sealing due to a surface pressure generated between the seal member and the inner peripheral surface and a self-sealing due to an internal fluid pressure.

In the pipe connector structure, both end surfaces of the tubular seal member are in a plane perpendicular to an axis of the tubular seal member, and the axial length of the tubular seal member is 5 to 20 times the thickness thereof.

Another aspect of the invention of the present application is a tubular seal member for a sealing mechanism for fluid used in combination with a pipe to be connected, in which the tubular seal member is made of fluororesin and has a thickness less than a thickness of the pipe, an axial length of the tubular seal member is 5 to 20 times the thickness of the above described tubular seal member, and an annular projection of a cross section of a right-angled triangle for engaging with an annular groove formed in an outer periphery of the pipe is formed on an inner periphery of the tubular seal member.

Another aspect of the invention of the present application is a pipe connector structure for interconnecting a conduit and a device main body, the conduit connector structure being configured to comprise a connector main body having a hole passing across both ends thereof into which a conduit to be connected is inserted and threads formed at both ends thereof, the connector main body being adapted to be connected to a device main body by one of the above described threads, and a fastening member having a through hole through which the conduit passes, the fastening member being to be engaged with the other of the threads of the connector main body, in which the conduit, connector main body, and fastening member are made of fluororesin, an annular groove is formed in an outer periphery of the conduit, and an annular projection engaging with the annular groove of the conduit is integrally formed on the fastening member, and a portion between the annular groove and an end of the conduit is axially compressed and deformed by at least 5% or more by the connector main body and the annular projection.

According to the present invention, since a thin tubular seal member made of fluororesin is in a state where it is compressed utilizing a extremely superior shape restoring capability thereof due to plastic memory, even when a creep occurs at the thread portion and a clearance is to be produced between the threads engaged with each other or between the conduit and a component of the connector structure that must be engaged with each other for sealing, the tubular seal member restores its original shape and extends to prevent the occurrence of the clearance, so that the leakage of the fluid does not occur, and therefore, the need for further fastening is eliminated.

The load area of an end face of a tubular seal member is decreased to contact under high pressure so that the end face of the tubular seal member made of hard fluoro-resin is in contact with a sealing surface, thereby keeping tubular seal member and the sealing surface in a tightly contacted state, and the height of the cylindrical body is increased (at least four times its thickness) for compensating poor impact resilience and shape recovery, thereby providing a seal member superior to those made of elastomer in that it can attain a desired shape recovery even if the compressive distortion factor is low (on the order of 5% to 10%, not limited thereto), and exhibits no extrusion even when a high pressure is applied thereto so that a smoothness of a flow path is not degraded.

For reference purposes, properties of elastomer used for typical seal members (O-ring), and TFE and PFA as the seal member, are briefly compared in Table 1 as described below.

TABLE 1
23° C.

| Material | Elastomer | TFE | PFA |
|---|---|---|---|
| Hardness | 70 | D50˜55 | D65 |
| | JIS(HIS) | ASTMD2240 | ASTMD1457 |
| Tensile stress | | | |
| (MPa) | | | |
| 5% | 0.1˜0.15 | 10 | 14 |
| 10% | 1.0˜1.5 | 12 | 16 |
| | | ASTMD1457 | ASTMD1457 |

Note that Hardness is represented in different scales for TFE and Elastomer.

As can be seen from the above table, TFE and PFA are not suitable for the seal member because they are inferior to elastomer in terms of the hardness (flexibility), the flexibility being essential for conformability to the sealed surface. Furthermore, the tensile stress of TFE and PFA is values nearly a hundred times that of elastomer (the value of TFE is listed as a guide for comparing the elasticity). Accordingly, TFE and PFA have quite poor flexibility. In order to use TFE and PFA having poor flexibility and high hardness for the seal member, high pressure (surface pressure) applied to the sealed surface for providing a conformability to the sealed surface, and shape recovery and impact resilience enough to fill the crevice caused by the creep at the fastening threads are required. Fortunately, among plastics, TFE and PFA have quite excellent properties in respect to shape recovery and plastic memory. The greatest feature of the present invention is to make use of these properties.

### BRIEF DESCRIPTION OF THE DRAWINGS

FIG. 1 is a cross-sectional view showing an example of a conventional pipe connector;

FIG. 2 is a cross-sectional view showing another example of a conventional pipe connector;

FIG. 3 is a cross-sectional view showing another example of a conventional pipe connector;

FIG. 4 is a cross-sectional view showing a further example of a conventional pipe connector;

FIG. 5 is a cross-sectional view showing an example of an external thread to be connected with a device main body in a conventional pipe connector;

FIG. 6A is a cross-sectional view of a fluid sealing mechanism for illustrating a principle of the fluid sealing mechanism using a tubular seal member according to the present invention, and FIG. 6B is an enlarged cross-sectional view of the tubular seal member;

FIG. 7 is a cross-sectional view showing another embodiment of the fluid sealing mechanism of the present invention;

FIG. 8 is a diagram illustrating the sealing of the tubular seal member;

FIG. 9 is a cross-sectional view of an embodiment of a pipe connector structure for interconnecting a device main body and a conduit (tube, pipe or the like), the structure comprising the fluid sealing mechanism according to the present invention;

FIGS. 10A and 10B show modifications of the pipe connector structure shown in FIG. 9;

FIG. 11A is a cross-sectional view of another embodiment of the pipe connector structure for interconnecting a device main body and a conduit, the structure comprising the fluid sealing mechanism according to the present invention, and FIG. 11B is a partial diagram of FIG. 11A, showing a tapered thread;

FIG. 12 is a cross-sectional view of further embodiment of the conduit connector structure comprising the fluid sealing mechanism according to the present invention;

FIG. 13 is a cross-sectional view of a further embodiment example of the pipe connector structure for interconnecting a device main body and a conduit, the structure comprising the fluid sealing mechanism according to the present invention;

FIG. 14 is a cross-sectional view of yet another embodiment of the pipe connector structure for interconnecting two conduits, the structure comprising the fluid sealing mechanism according to the present invention;

FIG. 15 shows a modification of a fastening member that can be used in combination with the connector main body of the pipe connector structure shown in FIG. 14;

FIG. 16 shows a modification of a fastening member that can be used in combination with the connector main body of the pipe connector structure shown in FIG. 14;

FIG. 17 is a cross-sectional view of a further embodiment of the pipe connector structure for interconnecting the device main body and the conduit according to the present invention; and

FIG. 18 is an enlarged cross-sectional view showing shapes of the annular projection formed on the tubular seal member or fastening member and of the annular groove formed in the conduit.

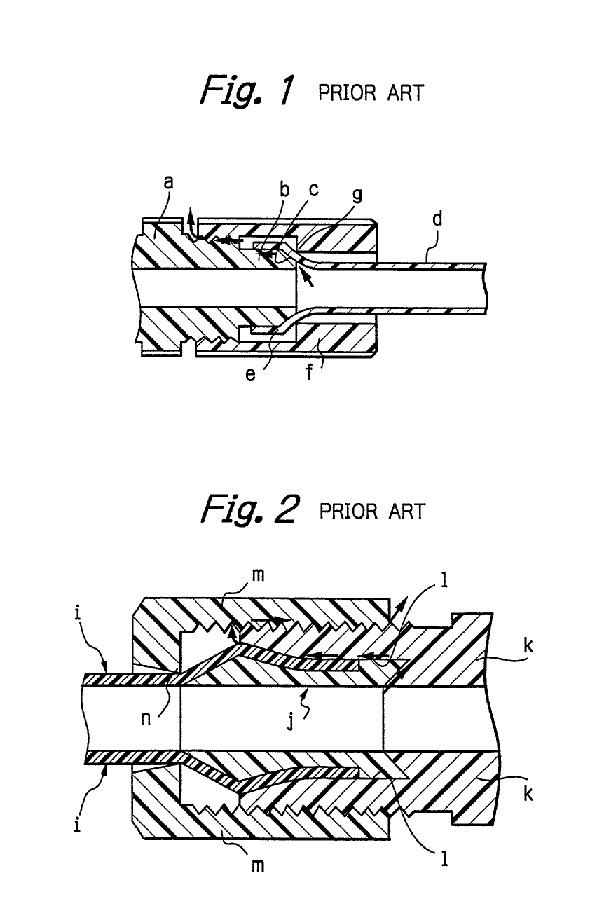

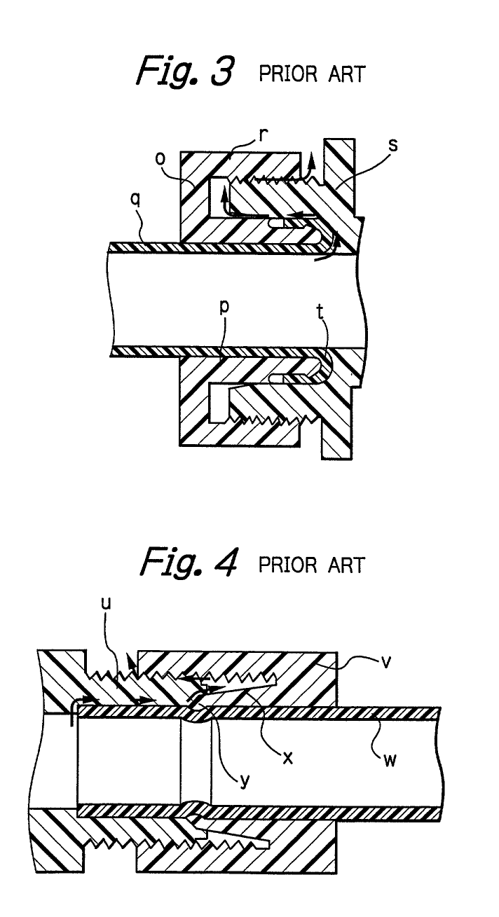

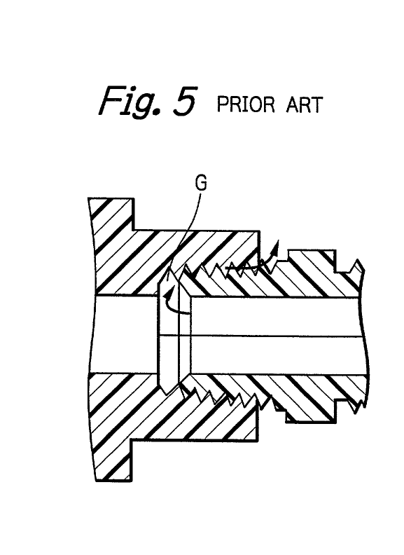

### DESCRIPTION OF THE PREFERRED EMBODIMENTS

Now, specific embodiments of a fluid sealing mechanism according to the present invention will be described below with reference to the drawings.

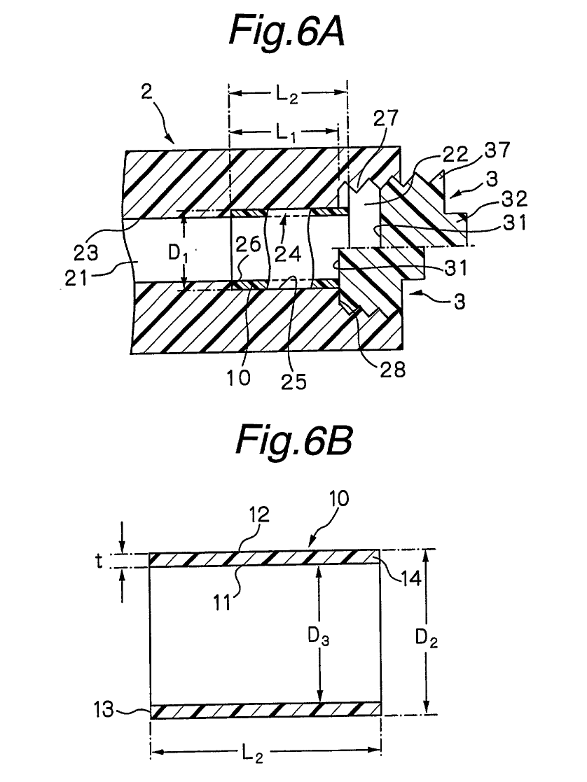

With reference to FIGS. 6A and 6B, a principle of the fluid sealing mechanism according to the present invention will be described. Here, a tubular seal member is used as a gasket. In the drawings, reference numeral 10 denotes a tubular seal member (hereinafter, simply referred to as a seal member) serving as a gasket, reference numeral 2 denotes a device main body or a part thereof including a container, valve, and the like (hereinafter, a main body portion), and reference numeral 3 denotes a closure member, such as a plug or lid, to be attached to the main body portion. The main body portion 2 has a cavity 21 of circular cross section for containing a fluid therein, the cavity 21 opening at a large diameter portion 22 at one end of the main body portion (right end in FIG. 6A). In an inner surface 23 defining the cavity 21, a receiving portion 24 extending by a length L₁ from the large diameter portion in the axial direction of the cavity 21 is formed. The receiving portion 24 is substantially coaxial with the inner surface 23 and has a cross section defined by a circular peripheral surface 25 (cylinder surface herein, the inner diameter being D₁) and a shoulder 26. The receiving portion 24 preferably has the peripheral surface 25 and shoulder 26 finished with surface roughness on the order of ∇∇∇ according to the machining standard of JIS. A tapered female thread 27 is formed in the inner peripheral surface of the large diameter portion 22 of the member 2. The shoulder 26 is formed so as to be substantially perpendicular to the axis of the peripheral surface 25. The requirement of the above described surface roughness is also applied to an end surface and outer peripheral surface of the seal member and a surface of a component that is brought into contact with these surfaces in the following embodiments.

The closure member 3 is cylindrical, and has a pressing surface 31 formed at one end thereof (left end in FIG. 6A) and a projection 32 for engaging with a tool formed at the other end thereof. The pressing surface 31 is formed with the same surface roughness as the peripheral surface 25 and shoulder 26 of the receiving portion. In the other outer peripheral surface of the closure member 3, there is formed with a tapered male thread 37 for engaging with the female thread 27 of the main body portion 2. In this embodiment, the tubular seal member 2 serving as a gasket is made of TFE and formed into a sleeve of outer diameter D₂, thickness t, and axial length L₂ (L₂>L₁). As shown in detail in FIG. 6B, a seal member 10 includes an inner peripheral surface 11, an outer peripheral surface 12, and end surfaces 13 and 14. While the end surfaces 13 and 14 are preferably formed so as to be substantially perpendicular to the axis of the seal member, the present invention should not be limited to this. Preferably, the outer diameter D₂ is equal to or slightly smaller than the inner diameter D₁ of the peripheral surface 25 of the receiving portion 24 of the closure member 3 so that the seal member can inserted into the receiving portion 24 without leaving a clearance. The inner diameter D₃ may be equal to the diameter of the inner surface 23. In addition, depending on the material and dimension, such as outer diameter, thickness, and axial length, of the seal member, the length L₂ is preferably longer than the length L₁ by 5 to 20%. This is because if the difference is less than 5%, it is not possible to attain a sufficient plastic memory effect, and if the difference is more than 20%, a great force is applied to the member, thereby promoting the creep occurring at the thread portion. It is not required to make the difference more than 20%. Furthermore, while the axial length L₂ of the seal member is preferably 5 to 20 times the thickness t, it may be larger than that. Furthermore, the thickness t preferably falls within the range of 0.8 mm to 3 mm inclusive. This is because if it becomes large and is beyond the range, the compressive deformation requires a strong pressing force, which adversely affects the member by applying an excessive load to the thread portion. However, the numerical range is not limited to the above described range.

In the state where the seal member 10 is simply inserted into the receiving portion 24 of the main body portion 2, as shown in the upper half of FIG. 6A, one end of the seal member 10 (right end in FIG. 6A) projects from a bottom surface 38 of the large diameter portion 32 toward the inside of the large diameter portion by a differential length of (L₂-L₁). Then, when an appropriate tool is inserted into the tool hole 32 of another closure member 3 to screw the closure member 3 into the main body portion 2, the end surface 14 of the seal member is brought into contact with the pressing surface 31 of the closure member 3 and thus axially pressed. Accordingly, the seal member 10 is axially compressed and thereby deformed. Thus, the end surface 13 of the seal member 10 comes into intimate contact with the shoulder 26 of the receiving portion 24 with a high pressure and the end surface 14 comes into intimate contact with the pressing surface 31 of the closure member 3 with a high pressure to form a tight seal, which can prevent a fluid in the cavity from leaking to the outside. In addition, since the pressure of the fluid in the cavity acts on the inner peripheral surface 21 of the seal member 2, the seal member is pressed against the peripheral surface (inner peripheral surface) 25 of the main body portion 2 so that it counters a press on the both members in a direction perpendicular to the axis. In this regard, when a tubular elastic body is axially compressed, it is hardly deformed to project inwardly, but it tends to be deformed to project outwardly or bulge out into the shape of a barrel, so that when the seal member is pressed axially, the outer peripheral surface of the seal member comes into intimate contact with the peripheral surface 25 of the main body portion. The closure member 3 is screwed into the main body portion 2 until the pressing surface 31 of the closure member 3 comes into contact with the bottom surface 28 of the main body portion 2 (the state shown in the lower half of FIG. 6A). While an axial squeeze of the seal member (amount of the axial compression of the seal member) depends on the material, size (such as thickness or axial length) and the like of the seal member, it preferably falls within the range of 5 to 20% of the axial length of the seal member for the above described reason. However, it is not limited to this numerical range.

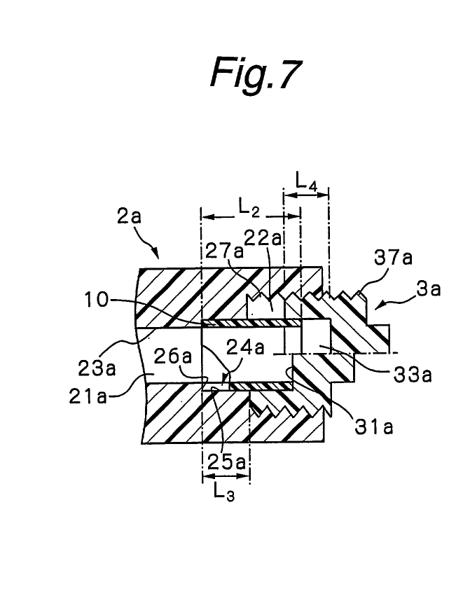

In FIG. 7, another example of usage of the seal member 10 is shown. In this example, the main body portion 2 and the closure member 3 are substantially the same as those shown in FIG. 6A except that the threads connecting them are parallel threads, and both may be made of synthetic resin or metal. This example differs from the example shown in FIG. 6A in that the receiving portion for the seal member 10 serving as a gasket is formed in both of the main body portion 2a and the closure member 3a, such as a plug or lid. That is, the axial length L3 of the receiving portion 24a formed in the main body portion 2a is less than a half of the axial length of the seal member. A recess 33a formed in the closure member 3a serves as the receiving portion 24a on the side of the closure member 3a, and the diameter of the peripheral surface 34a is substantially the same as the diameter of the peripheral surface (inner peripheral surface) 25a of the receiving portion 24a of the main body portion 2a. The bottom surface of the recess 33a constitutes the pressing surface 31a. Therefore, the peripheral surface 25a and shoulder 26a of the main body portion 2a and the peripheral surface 35a and pressing surface 31a of the closure member 3a are formed with surface roughness to the order of ∇∇∇ according to the machining standard of JIS. In addition, the depth L₄ of the recess is also less than a half of the axial length of the seal member. In this embodiment, the lengths L₁ and L₂ are not necessarily the same, and it is essential only that the relationship of L₃+L₄<L₂ is satisfied so that the seal member can be axially compressed and deformed by a predetermined amount when the closure member 3a is screwed into the main body portion 2a. Therefore, the receiving portion may not be formed on the side of the member 3 by defining L₃=0 and thus making the L₄ substantially equal to L₁ (the axial length of the seal member is L₂). For aspects other than that described above, the sealing mechanism is the same as the sealing mechanism 1 of the example shown in FIG. 6, and therefore, the detailed description thereof is omitted.

While in the above described embodiment shown in FIGS. 6A and 7, the male thread formed in the closure member itself, such as a plug or lid, is engaged with the female thread formed in the main body portion 2, if the diameter of the hole is large, and therefore the diameter of the tubular seal member is large and the lid is also large so that it is difficult to form the thread in the lid itself, the lid may be fixed to the main body portion by means of a plurality of fasteners such as bolts or set screws. Furthermore, in such a case, only the tubular seal member may be made of fluororesin, and the main body portion and the closure member may be made of metal.

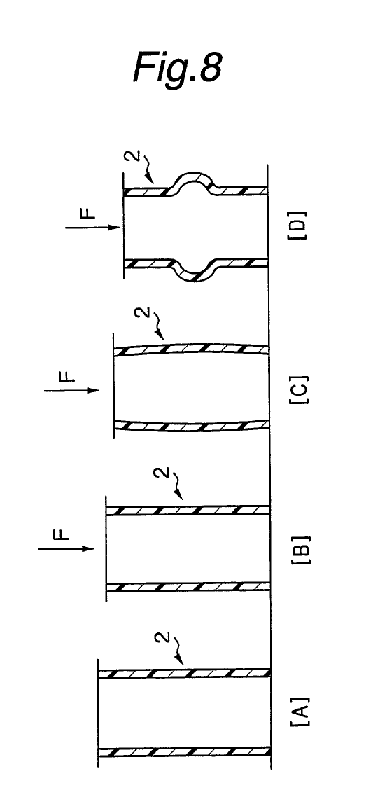

Now, the sealing property of the tubular seal member will be described. FIG. 8 illustrates where the seal member is deformed outwardly by compression. The axial load applied to the seal member 10 is gradually increased. In the case where the load F is increased starting from the state of no load shown in [A], when the load F is low and within the elastic limit of the material of the seal member, as shown in [B], the shape thereof is little altered except the height, that is, axial length, and when the load F is increased (middle load), as shown in [C], the middle portion in the axial direction slightly bulges outwardly. When the load F is further increased and beyond the elastic limit of the material, as shown in [D], buckling occurs and the middle portion bulges excessively. In the above described embodiment, the load F resulting in a state from [B] to [C] is adopted. In such a case, the compression ratio is 5 to 20%. While such an outward bulge is prevented because the peripheral surface of the member is in contact with the outside of the seal member, a secondary sealing mechanism including a sealing provided by the radial surface pressure (surface pressure between the outer periphery of the tubular seal member and the inner peripheral surface of the receiving portion) and a self-sealing mechanism provided by the inside fluid pressure is formed between the both end surfaces and peripheral surface of the seal member and the seal member. Particularly, if the connection point in the receiving portion is located at the middle in the axial length of the tubular seal member as shown in FIG. 7, the self-sealing mechanism functions effectively.

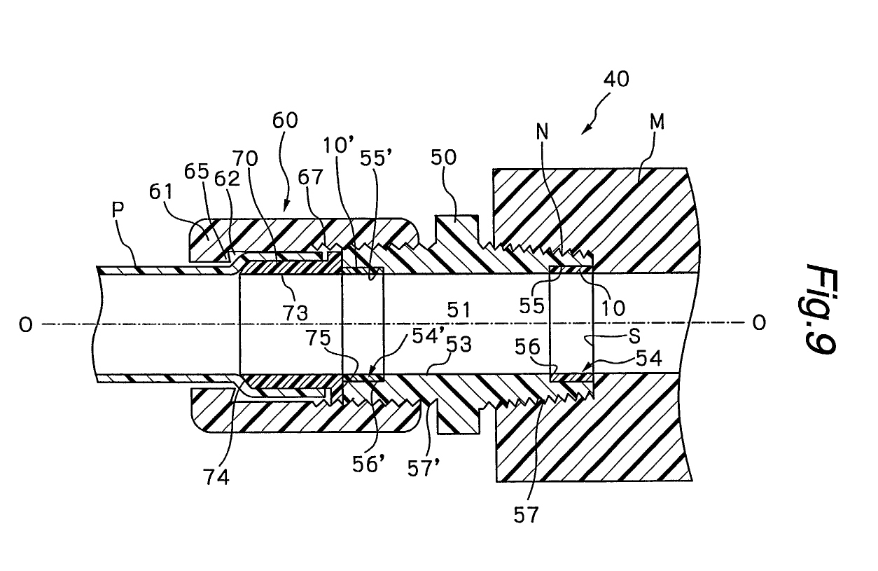

One embodiment of a pipe connector structure including a fluid sealing mechanism using the seal member 10 according to the present invention is shown in FIG. 9, the whole of which being denoted by reference numeral 40. In the pipe connector structure 40, the seal members 10 are used at two positions. The pipe connector structure is used primarily in a semiconductor manufacturing device, which is one of the applications of the present invention, for interconnecting a tube, pipe, or the like (hereinafter collectively referred to as a conduit) made of TFE or PFA used as a transport path for high purity chemicals, ultrapure water, or the like and a main body of another attached device, such as a valve, connectors, or pressure gauge. The pipe connector structure 40 according to one embodiment shown in FIG. 9 is a connector structure for interconnecting the device main body M, such as a valve, connectors, or pressure gauge and a conduit P, such as a pipe or tube. The pipe connector structure 40 comprises a connector main body 50 formed at one end thereof (right end in FIG. 9) with a tapered male thread 57 for engaging with a tapered female thread N formed in the device main body M, a fastening member or cap nut 60 formed with a parallel female thread 67 for engaging with a parallel male thread 57′ formed at the other end of the connector main body 50 (left end in FIG. 9), and an insert 70 that is placed in the connector main body 50 and cap nut 60 in a state where it is inserted into an end of the conduit P. While in this embodiment and embodiments described later, the connector main body 50, cap nut, that is, fastening member 60, and insert 70 are made of PFA by way of example, they may be made of TFE, and while the tubular seal member 10 is made of TFE by way of example, it may also be made of PFA. Alternatively, it may be made of other tetrafluoride resin. This applies to the materials of the components in the embodiments described below. In addition, the threads for connection with the device main body may be a parallel thread.

The connector main body 50 has a passage 51 (while in this embodiment, it has a circular cross section, though it is not limited to this) that passes through the connector main body in the axial direction (lateral direction in FIG. 9). At one end (right end in FIG. 9) of the inner surface 53 defining the passage 51, a first receiving portion 54 is formed. A first seal member 10 (made of TFE in this embodiment) having substantially the same structure and function as the seal member shown in FIG. 6B is mounted on the receiving 54. The diameter of the inner surface 73 of the insert 70 is substantially the same as that of the inner surface 53 of the connector main body, and the insert 70 has a tapered surface 74 formed at one end thereof (left end in FIG. 9) and a flat surface 75 engaging with the end surface 13 or 14 of the seal member 10 formed at the other end thereof.

At the other end (left end in FIG. 9) of the inner surface 53 defining the passage 51 in the connector main body 50, a receiving portion 54′ having substantially the same structure as the first receiving portion 54 is formed. A seal member 10′ having substantially the same structure as the first seal member is mounted on the receiving portion 54′. In this regard, the structure and function of the receiving portions 54 and 54′ defined by the peripheral surfaces 55 and 55′ and shoulder 56 and 56′, respectively, are the same as those of the receiving portion 24 formed in the main body portion 2 shown in FIG. 6A, and the relationship between the axial lengths of the receiving portions 54, 54′ and the axial lengths of the seal member 10, 10′ is also the same as that of the structure shown in FIG. 6A. Therefore, the detailed description thereof is omitted.

Connection of the connector main body 50 to the device main body M using the above described pipe connector structure 40 is accomplished in the following manner. First, in the state where the first seal member 10 is mounted on the inside of the first receiving portion 54 of the connector main body 50, the tapered male thread 57 is screwed into the tapered female thread N of the device main body M, thereby axially compressing the seal member that is longer in the axial direction than the receiving portion. Then, when the end surface (left end surface in FIG. 9) of the connector main body is brought into contact with the bottom surface S of the thread hole of the device main body 40, the connection of the connector main body to the device main body is completed. In such a condition, the seal member is compressed by at least 5% of its natural length (preferably 5 to 20%), the end surface of the seal member is brought into contact with the shoulder of the receiving portion 54 and bottom surface S of the thread hole of the device main body, and therefore the leakage of the fluid at the connection by the tapered male and female threads is prevented. Besides, even if creep occurs at the thread portion, restoring force due to the plastic memory of the seal member made of TFE prevents loosening at a thread coupling portion from occurring, thereby perfectly preventing the leakage of the fluid over a long time.

Next, as for connection of the connector main body 50 to the conduit P, the conduit P is inserted from its rear portion (left end in FIG. 9) into a stepped through hole 62 of the fastening member, that is, cap nut 60 in the first place, and the insert 70 is inserted into the open end of the conduit P. Then, in the state where the second seal member 10′ is mounted on the inside of the second receiving portion 54′ of the connector main body 50, the end surface 75 of the insert 70 is brought into contact with the end surface of the seal member, and the female thread 67 of the cap nut is engaged with the male thread 57′ of the connector main body. After the engagement of both the threads is pursued, the conduit P is pressed toward the insert by the shoulder 65 formed in the hole of the cap nut 60, and the end surface of the insert presses the end surface of the seal member 10 to axially compress the seal member 10′. Then, when the end surface of the insert is contact with the end surface of the connector main body, the connection of the connector main body to the conduit P is completed. In such a connection, the leakage of the fluid between the conduit P and the insert is prevented by the shoulder of the cap nut strongly pressing the pipe against the tapered surface of the insert, and the leakage of the fluid between the insert and the connector main body is prevented by the sealing engagement of the end surface of the seal member 10′ and the end surface 75 of the insert. In addition, when loosening is to occur due to creep at the thread portion, restoring force of the seal member prevents the loosening from occurring.

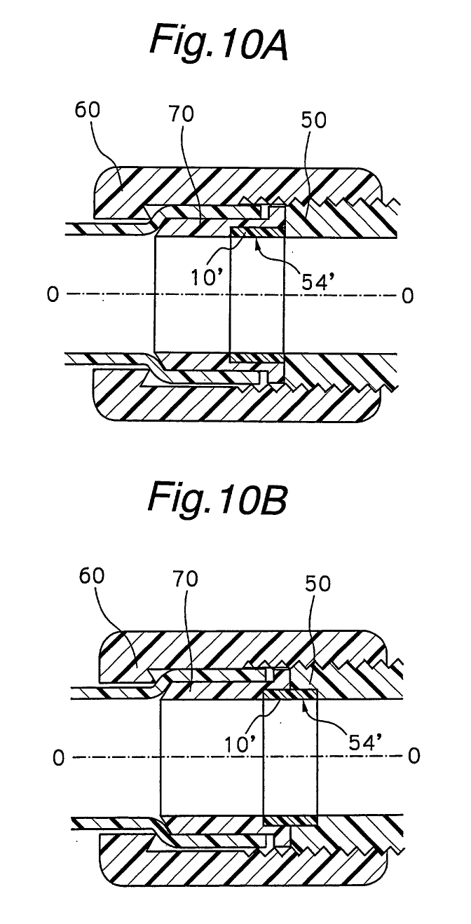

While the receiving portion 54′ is formed in the connector main body 50 in the above described, it may be formed in the insert 70 as shown in FIG. 10A or in both the connector main body 50 and insert 70 as shown in FIG. 10B.

Next, experimental results of a leakage test for the first seal member receiving in the first receiving portion 54 in FIG. 9 will be described.

As shown in FIG. 9, when a test was carried out under the condition that a ¾ PT thread was used as the thread 57 of the connector main body 50, the fluid pressure was 2 MPa, the initial tightening torque was 15 Kg·Cm, the additional tightening torque after a lapse of 24 hours was 20 Kg·Cm, and the temperature was 23° C., although a creep should have occurred at the sealed portion, the shape recovery effect of the seal member of the present invention prevented any passage from appearing so that no liquid leakage occurred, and the male thread could be additionally tightened a ¼ of a turn. Since the pitch of the thread was 1.81 mm, the amount of the creep proved to be ¼ of the pitch (0.45 mm). Therefore, it was proved that the initial compression amount required to fill the crevice of 0.45 mm wide was 1 mm, assuming that the permanent strain was 50%. In consideration of the permanent strain of TFE (50%), shape recovery (50%), and residual stress (50%) at the time of stress relaxation, it proved that the required initial compressive strain factor and shrinkage were 10% and 1 mm, respectively. (Typically, an average compression (squeeze) for fixing an O-ring made of elastomer is about 20% to 30% of the diameter of the O-ring.)

Since the stress of 10% compression strain was 17 MPa (slightly different from the value of the tensile strain stress), and it is required to minimize a pressure receiving area of the cylindrical body in order to reduce a load exerted thereto for compression, the inner diameter and outer diameter was set at 16 mm and 18 mm (the thickness of the wall was 1 mm), respectively, and therefore the cross-sectional area was approximately 0.53 cm². Accordingly, a load pressure assumed the small value of 17 MPa×0.53=9.01 MPa. The original height of the cylindrical body was 10 mm, and the height thereof after compression by 10% was 9 mm.

In general, the seal member used in the connector made of TFE having a ¾ PT thread was a sleeve originally having dimensions of 18 mm in outer diameter, 16 mm in inner diameter and 10 mm in axial length, which had dimensions of 18 mm in outer diameter, 16 mm in inner diameter and 9 mm in axial length during use. In addition, the fluid pressure for the leakage was 2 MPa, and the sealed surface pressure of the connector was 9 MPa. Therefore, a 4.5 safety factor in terms of sealing was provided.

As for the leakage occurring between the main body and tube-coupling body due to the creep of a first cap nut thread, the description thereof will be omitted, because there is the above-described connector of the present invention at the position and its sealing effect is provided in the same manner.

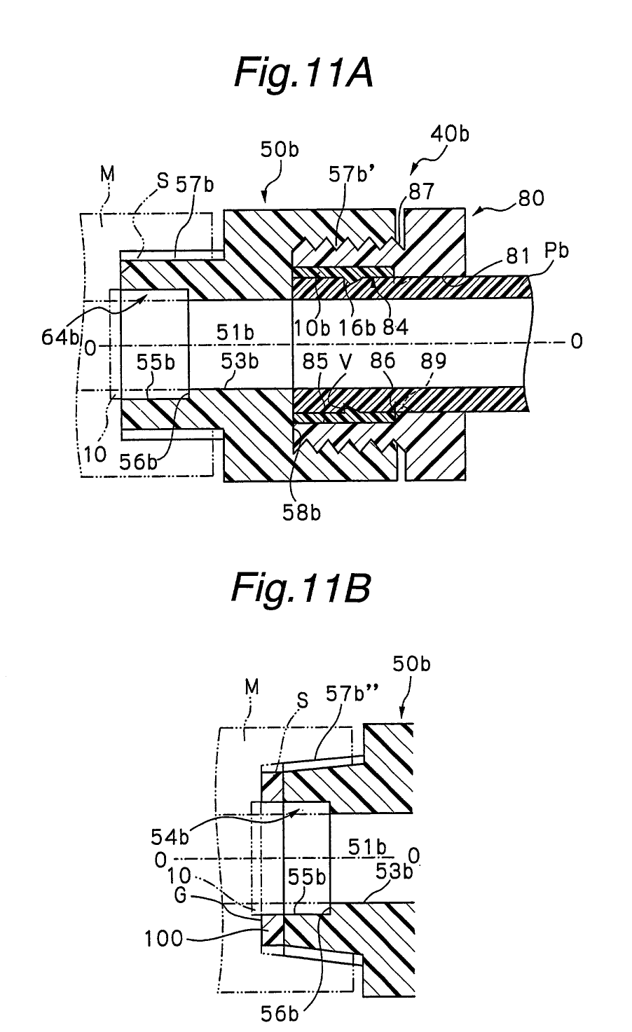

In FIG. 11A, there is shown another embodiment of the pipe connector structure adopting the fluid sealing mechanism of the present invention, the entirety of which is denoted by reference numeral 40b, that is used for connecting a pipe to a main body of another attached device, such as a valve, connectors, pressure gauge. In this pipe connector structure 40b, the structure and function of the portion that interconnects the connector main body 50 and the device main body M are the same as those of the equivalent portion of the pipe connector structure shown in FIG. 9 except that the threads are parallel threads. Therefore, the same components as those in FIG. 9 are assigned the same reference numerals with the suffix b, and the detailed description thereof is omitted. The pipe connector structure 40b comprises a connector main body 50b, and a fastening member 80 having a structure that is substantially different from that of the fastening member 60 of the pipe connector structure 40 shown in FIG. 9. The connector main body 50b has a passage 51b that passes through the connector main body in the axial direction (lateral direction in FIG. 11A). The passage has a larger diameter at one end (right end in FIG. 11A) of the inner surface 53b defining the passage 51b, on the inner periphery of which a parallel female thread 57b′ is formed.

The fastening member 80 is constituted by a ring body having a hole 81 passing therethrough in the axial direction (lateral direction in FIG. 11A) and a parallel male thread 87 for engaging with the female thread 57b′ of the connector main body 50b. On the inner periphery of one end of the fastening member 80 (the end portion that is located at the left end and has the male thread 87 formed thereon in FIG. 11A), a receiving portion 84 having substantially the same structure and function as the receiving portion formed in the main body portion shown in FIG. 6A is formed. A second seal member 10b (made of TFE in this embodiment) having substantially the same structure and function as the seal member 10 shown in FIG. 6B is mounted on the inside of the receiving portion 84. In this regard, the structure and function of the receiving portion 84 defined by the peripheral surfaces 85 and shoulder 86 are the same as those of the receiving portion 24 formed in the main body portion 2 shown in FIG. 6A, and the relationship between the axial length of the receiving portion 84 and the axial length of the seal member 10b is also the same as that of the structure shown in FIG. 6A. Therefore, the detailed description thereof is omitted. The seal member 10b of this embodiment differs from the seal member 10 shown in FIGS. 6A and 6B in that an annular projection 16b for engaging with an annular groove V formed in the outer periphery of the conduit Pb is formed on the inner periphery of the seal member 10b.

Next, as for connection of the connector main body 50b to the conduit Pb, the conduit Pb is inserted from its rear portion (right end in FIG. 11A) into the through hole 81b of the fastening member 80 in the first place, so that the open end of the conduit Pb is made to project outwardly from the fastening member. Then, the seal member 10b is fitted over the outer periphery of the open end of the conduit Pb in such a manner that the annular projection 16b is engaged with the annular groove V. Then, the seal member and the conduit Pb are relatively moved with respect to the fastening member until the seal member 10b is entirely received in the receiving portion 84 of the fastening member 80. Then, the male thread 87 of the fastening member 80 is engaged with the female thread 57b′ of the connector main body 50b, thereby axially compressing the seal member 10b by a predetermined amount (5 to 20%) by the action of the connector main body 50b and the fastening member 80. Thus, the connection of the conduit Pb to the connector main body 50 is completed. In such a connection, the leakage of the fluid between the conduit Pb and the fastening member 80 is prevented by the annular projection 16b of the seal member 10b tightly and strongly engaging with the annular groove V of the conduit, and the leakage of the fluid between the connector main body and the fastening member is prevented by the strong sealing engagement of the end surface of the seal member 10b and the bottom surface 58b of the connector main body. Also, when loosening is to occur due to creep at the thread portion, restoring force of the seal member prevents it. In addition, no clearance occurs between the end surface of the conduit and the bottom surface 58b of the connector main body, so that no liquid pool occurs. In this regard, while the annular projection 16b is provided on the inner periphery of the seal member 10b in this embodiment, a projection 89, which is shown by a broken line in FIG. 11A, may be integrally formed on the inner periphery of the fastening member 80 at a position adjacent to the shoulder 86 defining the receiving portion.

In the above described embodiment, the threads for connecting the connector main body 50b to the device main body M are shown to be parallel threads. This is because in the case of the parallel thread, when the connector main body 50b is attached to the device main body M, the threads are engaged with each other until the tip end of the thread comes into contact with the bottom surface S so that no clearance occurs therebetween. If a tapered thread 57″ is used as the thread of this portion, an annular spacer 100 for filling a clearance G between the tip end of the thread and the bottom surface of the device main body M may be used, or the tip end portion of the thread may be extended. In such a case, the inner diameter of the spacer 100 is the same as the diameter of the peripheral surface 55b defining the receiving 54b formed in the connector main body.

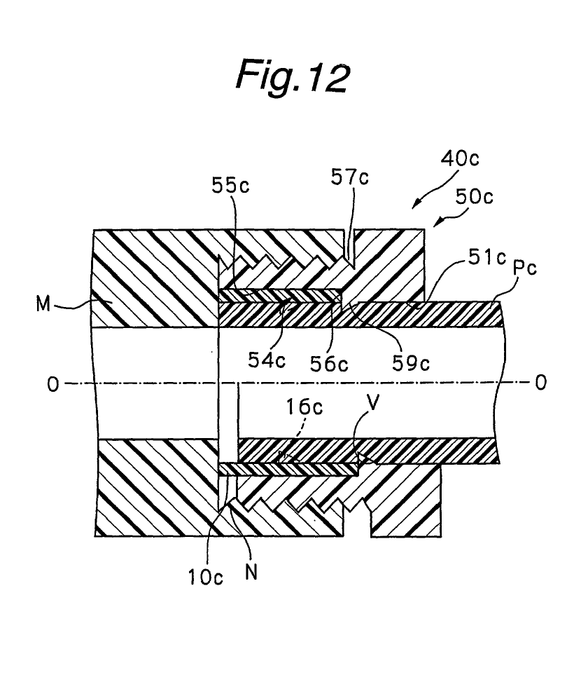

FIG. 12 shows an embodiment of the pipe connector structure in which a member having a structure essentially the same as that of the fastening member shown in FIG. 11A is adopted as a connector main body and the connector main body is engaged with the internal thread of the device main body to connect a conduit Pc to the device main body. The connector main body 50c of the pipe connector structure 40c of this embodiment has a through hole 51c. A parallel male thread 57c for engaging with the female thread of the device main body is formed on the outer periphery of one end (left end if FIG. 12) of the connector main body, and a receiving portion 54c is formed on the inner periphery of the through hole 51c. In the connector main body, an annular projection 59c for engaging with the V-shaped annular groove V formed in the outer periphery of the conduit Pc is formed at a position adjacent to a shoulder 56c defining a receiving portion 54c. A seal member 10c having the same structure and function as those of the seal member shown in FIGS. 6A and 6B is disposed in the receiving portion 54c. In this regard, the structure and function of the receiving portion 54c defined by the peripheral surfaces 55c and shoulder 56c are the same as those of the receiving portion 24 formed in the main body portion 2 shown in FIG. 6A, and the relationship between the axial length of the receiving portion 84c and the axial length of the seal member 10c is also the same as that of the structure shown in FIG. 6A. Therefore, the detailed description thereof is omitted.

With this pipe connector structure, connection of the pipe to the device main body is completed simply by engaging the male thread 57c of the connector main body with the female thread N of the device main body M in the state where the annular projection formed on the connector main body is engaged with the annular groove V of the conduit and axially compressing the seal member between the connector main body and the device main body, and the number of the components can be one fewer than the embodiment shown in FIG. 11A so that the structure can be simplified. In addition, no clearance occurs between the end surface of the conduit and the bottom surface of the connector main body, so that no liquid pool occurs. In this regard, the annular projection for engaging with the annular groove of the pipe may be formed on the inner periphery of the seal member 10c as shown as an annular projection 16c by a broken line in FIG. 12.

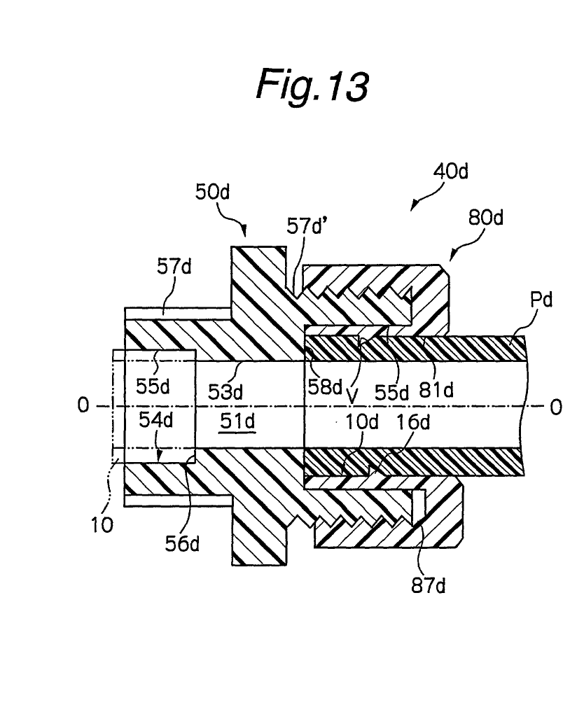

In FIG. 13, there is shown another embodiment of the pipe connector structure, the entirety of which is denoted by reference numeral 40d. In this pipe connector structure 40d, the structure and function of the portion that interconnects the connector main body 50d and the device main body (not shown) are the same as those of the equivalent portion of the pipe connector structure shown in FIG. 9 except that the threads are parallel threads. Therefore, the same components as those in FIG. 9 are assigned the same reference numerals with the suffix d, and the detailed description thereof is omitted. The pipe connector structure 40d comprises a connector main body 50d, and a fastening member 80d. The connector main body 50d has a passage 51d that passes therethrough in the axial direction (passes therethrough in the lateral direction in FIG. 13). In this passage, a conduit Pd to be connected and a seal member 10d formed integrally with the fastening member 80d are received. A parallel male thread 57d′ is formed on the outer periphery of an end of the connector main body 50d.

The fastening member 80d is constituted by a ring body 81d having a hole 81d passing therethrough in the axial direction (lateral direction in FIG. 12) and a parallel male thread 87d for engaging with a female thread 57d′ of the connector main body 50d. The outer annular portion on which the external thread 87d is formed and the seal member 10d are formed coaxially and integrally. Therefore, unlike the fastening members 80 and 80c shown in FIGS. 12 and 13, the fastening member 80d has no receiving portion. An inner peripheral surface 55d′ of the connector main body 50d that receives the seal member 10d constitutes the receiving portion. An annular projection 16d for engaging with the annular groove V formed in the conduit Pd is formed on the inner peripheral surface of the seal member 10d formed integrally with the fastening member 80d. The seal member 10d has substantially the same structure and function as the seal member 10 shown in FIG. 6B except that it is formed integrally with the fastening member.

In FIG. 13, the conduit Pd is connected to the connector main body by engaging the fastening member 80d formed integrally with the tubular seal member 10d having the annular projection 16d with the connector main body 50d. However, if the connection end (right end) of the device main body shown in FIG. 12 is constructed the same as the right-side portion of the connector main body in FIG. 13, the device main body can be connector to the pipe simply by using the connector main body or fastening member having the same structure as the fastening member 80d.

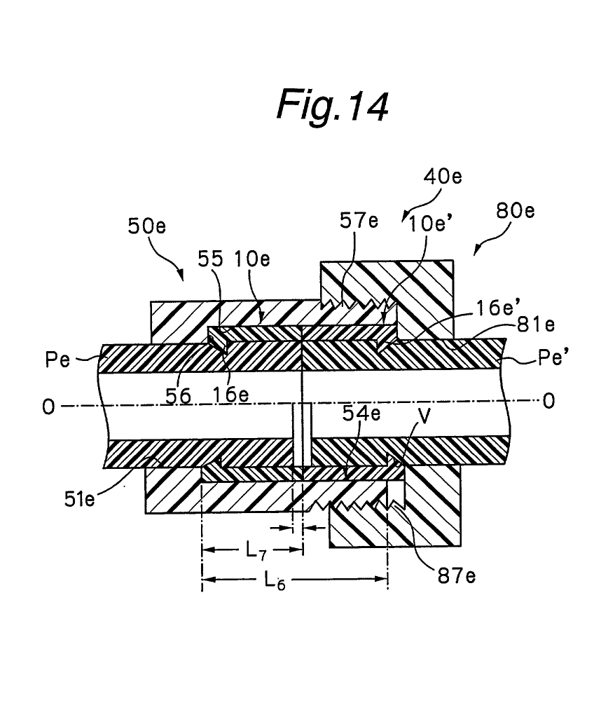

In FIG. 14, there is shown another embodiment of the pipe connector structure for connecting two pipes with each other that is provided with the fluid sealing mechanism of the present invention. The pipe connector structure of this embodiment comprises a connector main body 50e constituted by a tubular body 51e having a through hole 51e and a parallel male thread 57e formed at one end thereof (right end in FIG. 14), a pair of seal members 10e, 10e′ disposed in the connector main body 50e, and a fastening member, that is, nut 80e having a parallel female thread 87e for engaging with the external thread of the connector main body 50e. In the through hole 51e of the connector main body 50e, a receiving portion 54e for receiving the seal member is formed. The structure and function of the receiving portion 54e defined by the peripheral surfaces 55e and shoulder 56e are the same as those of the receiving portion 24 formed in the main body portion 2 shown in FIG. 6A, and the relationship between the axial length L₆ of the receiving portion 84e and the axial length 2L of the sum of the lengths of the pair of seal members 10e, 10e′ (based on the fact both the two seal members have the same length of L₇ in this example) is also the same as that of the structure shown in FIG. 6A. Therefore, the detailed description thereof is omitted. On the inner peripheries of the end portions of the pair of seal members 10e and 10e′, there are formed annular projections 16e and 16e′, respectively, for engaging with the annular grooves formed in the outer periphery of the conduit Pe to be connected.

Engagement of the thread 57e of the connector main body and the thread 87e of the fastening member 80e is continued until the two seal members, which are in the state where they are received in the receiving portion and are not axially compressed as shown in the lower half of the FIG. 14, are entirely compressed as shown in the upper half of FIG. 14. Thus, the leakage of the fluid between the conduit Pd and the fastening member 80d is prevented by the annular projection 16d of the seal member 10d tightly and strongly engaging with the annular groove V of the pipe, and the leakage of the fluid between the connector main body and the fastening member is prevented by the strong sealing engagement of the end surface of the seal member 10d and the bottom surface 58b of the connector main body. Also, when loosening is to occur due to creep at the thread portion, restoring force of the seal member prevents the loosening from occurring.

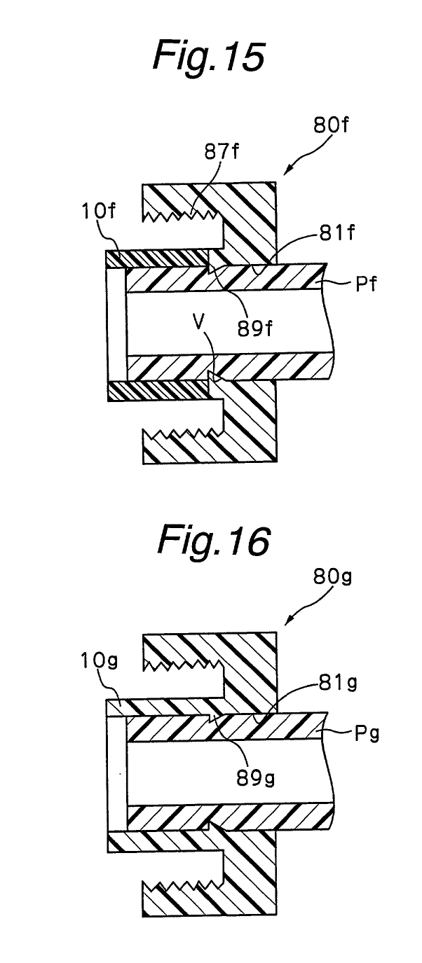

FIG. 15 shows a modification of the fastening member or nut that can be used in combination with the connector main body shown in FIG. 14. In this modification, an annular projection 89f for engaging with the annular groove V formed in the outer periphery of the conduit is formed on the inner periphery of a through hole 81f of a fastening member 80f, and there is no annular projection formed on one seal member 10f of the fastening member. FIG. 16 shows another modification of the fastening member or nut that can be used in combination with the connector main body shown in FIG. 14. In this modification, an annular projection 89g for engaging with the annular groove formed in the outer periphery of the conduit is formed on the inner periphery of a through hole 82g of a fastening member 80g, and the fastening member and one seal member 19g of the fastening member are formed integrally. Other aspects are the same as the pipe connector structure described with reference to FIG. 15, and therefore, the detailed description thereof is omitted.

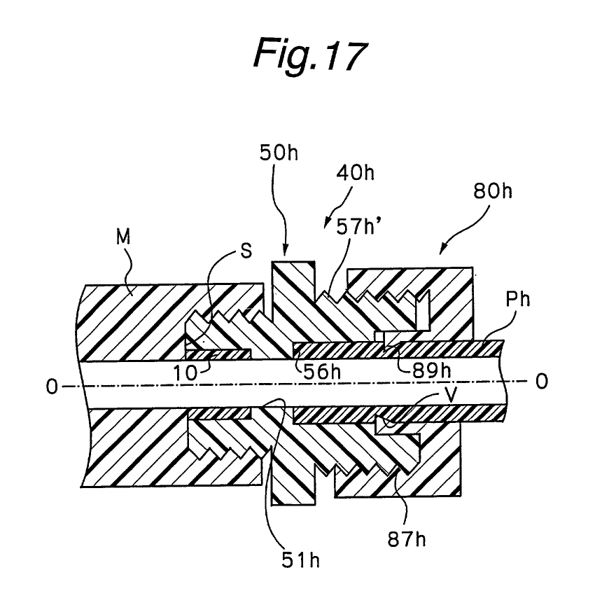

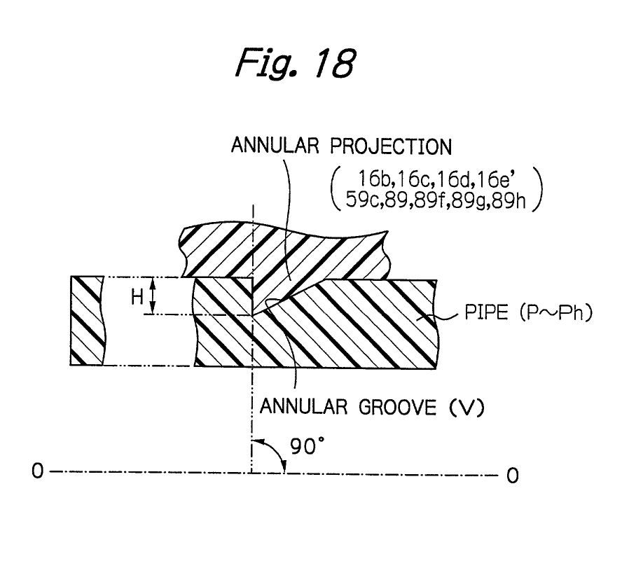

FIG. 17 shows a pipe connector structure in which a portion extending between the V-shaped groove of the conduit Ph to be connected and an end surface thereof is used as the tubular seal member of the present invention. In this pipe connector structure 40h, a through hole 51h is formed in a connector main body 51h, and the conduit Ph to be connected is passed through a part thereof (a portion of a larger diameter located at the right of FIG. 17). A male thread 57h formed in one end of the connector main body 50h (left side of FIG. 18) is engaged with an internal thread of the device main body M. The sealing at the joint between the connector main body and the device main body is accomplished using a seal member in the same manner as the equivalent portion of the pipe connector structure in FIGS. 11 and 13, and therefore the description thereof is omitted. A parallel male thread 57h′ formed in the other end of the connector main body is configured to be engaged with a female thread 87h of the fastening member 80h. The inner periphery of the opening of the latter end of the connector main body has a larger diameter, and a tubular protrusion of the fastening member 80h is inserted into it. In addition, an annular projection 89h for engaging with the annular groove V formed in the outer periphery of the conduit Ph is formed on the inner periphery of the tubular protrusion. When the fastening member 80h is moved toward the connector main body by engaging the fastening member with the connector main body, the tip end of the pipe (left end in FIG. 18) collides with a shoulder 86h of the connector main body and thus the movement thereof is restricted, so that the tip end portion of the pipe (a portion to the left of the annular projection in the drawing) is axially pressed by the annular projection 89h to be compressed. Therefore, the strong and tight engagement of the tip end surface of the pipe and shoulder of the connector main body prevents the leakage of the fluid between the end portion of the pipe and the connector main body. Furthermore, due to elastic deformation of the pipe, restoring force of the pipe prevents occurrence of loosening due to creep in the thread of the pipe connector structure.

Preferably, in the above described example, the thickness of the pipe is 1 mm or less, the inner diameter thereof is 16.0 mm or less, and the compression ratio is 10% or less. This is because in terms of the load, that is, shearing stress applied when the pipe is pressed by a projection of rectangular cross section, it is difficult to ensure a desired compression amount with a thick conduit.

In the above described embodiment, the shape of the cross section of the annular projection (formed on the seal member, connector main body, or fastening member) for engaging with the annular groove formed in the outer periphery of the conduit is a right-angled triangle as apparent from FIGS. 11 to 17 and 18, and the surface thereof at the side of the end of the conduit (the end of the object to be connected, that is, on the left side of FIG. 18) is perpendicular to the axis line 0-0 of the seal member and connector main body. Therefore, the cross section of the annular groove formed in the outer periphery of the conduit is made to have a shape corresponding to the cross section of the annular projection. In addition, the annular groove and annular projection are formed with substantially the same surface roughness as the above described seal member. Furthermore, in general, a radial projection height of the annular projection (accordingly, a radial recess depth H of the annular groove), which depends on the outer diameter and thickness of the conduit to be connected, is preferably about one-third of the thickness of the conduit.

In the above described embodiments, the case has been described in which structural elements such as the device main body, connector main body, fastening member to be engaged with the connector main body and insert, the tubular seal member, and the conduit to be connected (tube or pipe) are made of TFE or PFA, that is fluororesin material. However, the sealing mechanism of the present invention can be effectively applied to the case where the above structural elements are made of a material such as a resin other than fluororesin or metal. In addition, except for the embodiment shown in FIG. 17, the present invention can be applied to the case where the pipe is made of a material such as a resin other than fluororesin, metal, or glass.

According to the present invention, the following advantages can be provided.

(i) Since the tubular seal member made of fluororesin is used in the state where it is axially compressed and deformed, even if two structures to be interconnected are made of a plastic, which easily causes creep at the coupling thread portion, the seal member prevents occurrence of a clearance due to the creep by the action of its restoring force, and a superior sealing effect can be provided.

(ii) Since the tubular seal member made of fluororesin of the same quality as the connector main body, a pipe connector structure having superior chemical resistance, heat resistance, pressure resistance, reliability, and convenience can be provided.

(iii) A flat and stepless fluid path having no liquid pool can be provided.

(iv) In the piping operation, heat is not used and the operation is quite simplified.

(v) The structure can be simplified and downsized so that the production cost is significantly reduced.

(vi) Application to a thick pipe and a pipe of a large diameter is possible.

(vii) Effective application to a connector structure for a metal pipe, glass pipe, rigid plastic pipe, or the like is possible.

What is claimed is:

1. A sealing mechanism for fluid for preventing leakage of fluid from a portion of threads of two members that are connected to each other via said threads, at least one of the two members having a hole for accommodating the fluid formed therein, comprising:
a receiving portion formed in an inner periphery of said hole and having a diameter larger than a diameter of said hole and a desired axial length; and
a tubular seal member having an axial length longer than the axial length of said receiving portion, characterized in that
said tubular seal member is made of fluororesin, and
when said two members are interconnected by engagement of said threads, said tubular seal member is axially compressed and deformed by at least 5% or more, thereby providing a strong sealing on at least one end surface of said tubular seal member, and at the same time said tubular seal member is pressed in contact with the inner peripheral surface of the receiving portion, thereby providing a sealing due to a surface pressure generated between the seal member and the inner peripheral surface and a self-sealing due to an inside fluid pressure.

2. The sealing mechanism for fluid according to claim 1, characterized in that
one of said two members is a fluidic device main body, and the other is a closure member to be engaged with said device main body,
said hole is formed in at least said device main body, and
said receiving portion is formed in at least one of the hole of said device main body and the closure member.

3. The sealing mechanism for fluid according to claim 1, characterized in that
one of said two members is a fluidic device main body, and the other is a connector main body of a pipe connector for connecting a pipe to said device main body,
said hole is formed in both of said device main body and said connector main body, the holes being axially aligned with each other, and
said receiving portion is formed in at least one of the hole of said device main body and the hole of the connector main body.

4. The sealing mechanism for fluid according to claim 1, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

5. The sealing mechanism for fluid according to claim 2, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

6. The sealing mechanism for fluid according to claim 3, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

7. The sealing mechanism for fluid according to claim 1, characterized in that
one of said two members is a connector main body of a pipe connector, and the other is a fastening member to be engaged with said connector main body via a thread,
said hole is formed in both of said connector main body and said fastening member, the diameter of the hole of said fastening member being larger than the diameter of the hole of said connector main body,
said receiving portion is formed in the hole of said fastening member,
a pipe to be connected to said connector main body is inserted into said hole of said fastening member, and
an annular projection for engaging with an annular groove formed in an outer periphery of said pipe is formed on an inner periphery of the tubular seal member to be accommodated in said receiving portion or an inner periphery of said fastening member.

8. The pipe connector structure according to claim 7, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

9. The sealing mechanism for fluid according to claim 1, characterized in that
one of said two members is a fluidic device main body, and the other is a connector main body of a pipe connector for connecting a pipe to said device main body,
said hole is formed in both of said device main body and said connector main body, the diameter of the hole of said connector main body being larger than the diameter of the hole of said device main body, and
said receiving portion is formed in the hole of said device main body,
a pipe to be connected to said device main body is inserted into said hole of said connector main body, and
an annular projection for engaging with an annular groove formed in an outer periphery of said pipe is formed on an inner periphery of the tubular seal member to be accommodated in said receiving portion or an inner periphery of said device main body.

10. The pipe connector structure according to claim 9, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

11. The sealing mechanism for fluid according to claim 1, characterized in that
one of said two members is a connector main body of a pipe connector, and the other is a fastening member to be engaged with said connector main body via a thread,
said hole is formed in both of said connector main body and said fastening member, the diameter of the hole of said fastening member being larger than the diameter of the hole of said connector main body,
a pipe to be connected to said device main body is inserted into said hole of said connector main body, and
said tubular seal member is formed integrally with said fastening member, and an annular projection for engaging with an annular groove formed in an outer periphery of said pipe is formed on an inner periphery thereof.

12. The pipe connector structure according to claim 11, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

13. The sealing mechanism for fluid according to claim 1, characterized in that
one of said two members is a connector main body of a pipe connector for connecting two pipes to each other, and the other is a fastening member to be engaged with said connector main body via a thread,
said hole is formed in both of said connector main body and said fastening member, the holes being aligned with each other, and
said receiving portion is formed in the hole of said connector main body,
said pipes to be connected to each other are inserted into said holes of said connector main body and said fastening member, respectively,
the tubular seal member to be accommodated in said receiving portion is constituted by two tubular seal members that are in contact with each other at one end thereof, the axial length of said receiving portion being longer than an axial length of one of said tubular seal members and shorter than the sum of axial lengths of two tubular seal members, and
an annular projection for engaging with an annular groove formed in an outer periphery of one pipe is formed on an inner periphery of one of the tubular seal members, and an annular projection for engaging with an annular groove formed in an outer periphery of the other pipe is formed on an inner periphery of the other of the tubular seal members.

14. The pipe connector structure according to claim 13, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

15. The sealing mechanism for fluid according to claim 1, characterized in that
one of said two members is a connector main body of a pipe connector for connecting two pipes to each other, and the other is a fastening member to be engaged with said connector main body via a thread,
said hole is formed in both of said connector main body and said fastening member, the holes of both bodies being aligned with each other, and
said receiving portion is formed in the hole of said connector main body,
said pipes to be connected to each other are inserted into said holes of said connector main body and said fastening member, respectively,
the tubular seal member to be accommodated in said receiving portion is constituted by two tubular seal members that are in contact with each other at one end thereof, the axial length of said receiving portion being longer than an axial length of one of said tubular seal members and shorter than the sum of axial lengths of two tubular seal members, and
an annular projection for engaging with an annular groove formed in an outer periphery of one pipe is formed on an inner periphery of one of the tubular seal members, and an annular projection for engaging with an annular groove formed in an outer periphery of the other pipe is formed on an inner periphery of said fastening member.

16. The pipe connector structure according to claim 15, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

17. The sealing mechanism for fluid according to claim 1, characterized in that
one of said two members is a connector main body of a pipe connector for connecting two pipes to each other, and the other is a fastening member to be engaged with said connector main body via a thread,
said hole is formed in both of said connector main body and said fastening member, the holes being aligned with each other, and
said receiving portion is formed in the hole of said connector main body,
said pipes to be connected to each other are inserted into said holes of said connector main body and said fastening member, respectively,
the tubular seal member to be accommodated in said receiving portion is constituted by two tubular seal members that are in contact with each other at one end thereof, the axial length of said receiving portion being longer than an axial length of one of said tubular seal members and shorter than the sum of axial lengths of two tubular seal members, and
an annular projection for engaging with an annular groove formed in an outer periphery of one pipe is formed on an inner periphery of one of the tubular seal members, the other of the tubular seal member is formed integrally with said fastening member and has an annular projection for engaging with an annular groove formed in an outer periphery of the other pipe, which is formed on an inner periphery thereof.

18. The pipe connector structure according to claim 17, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

19. The sealing mechanism for fluid according to claim 1, characterized in that
one of said two members is a connector main body of a pipe connector, and the other is a fastening member to be engaged with said connector main body via a thread,
said sealing mechanism further comprises a tubular insert disposed in said fastening member in a state where the tubular insert is inserted into an end of said pipe to be connected to said connector main body,
said hole is formed in both of said connector main body and said tubular insert, the holes being aligned with each other,
said receiving portion is formed in at least one of the holes of said connector main body and said tubular insert, and
said tubular insert is made of fluororesin.

20. The pipe connector structure according to claim 19, in which both end surfaces of said tubular seal member is in a plane perpendicular to an axis of said tubular seal member, a thickness of the tubular seal member is 0.8 mm or more, and the axial length of said tubular seal member is 5 to 20 times the thickness thereof.

21. A pipe connector structure according to claim 19, in which said receiving portion is formed in both of said connector main body and said tubular insert.

22. A tubular seal member for a sealing mechanism for fluid used in combination with a pipe to be connected, in which
said tubular seal member is made of fluororesin and has a thickness less than a thickness of said pipe,
an axial length of said tubular seal member is 5 to 20 times the thickness of said tubular seal member, and
an annular projection of a cross section of a right-angled triangle for engaging with an annular groove formed in an outer periphery of said pipe is formed on an inner periphery of said tubular seal member.

23. The pipe connector structure according to claim 22, in which both end surfaces of said tubular seal member is in a plane perpendicular to an axis of said tubular seal member, a thickness of the tubular seal member is 0.8 mm or more.

24. A pipe connector structure for interconnecting a pipe and a device main body, comprising:
a connector main body having a hole passing across both ends thereof into which a pipe to be connected is inserted and threads formed at both ends thereof, the connector main body being adapted to be connected to a device main body by one of said threads; and
a fastening member having a through hole through which said pipe passes, the fastening member being to be engaged with the other of said threads of said connector main body, in which
said pipe is made of fluororesin,
an annular groove is formed in an outer periphery of said pipe, and an annular projection for engaging with the annular groove of said pipe is integrally formed on said fastening member, and
a portion between said annular groove and an end of said pipe is axially compressed and deformed by at least 5% or more by said connector main body and said annular projection.
